(19) United States
(12) Patent Application Publication
(10) Pub. No.: US 2025/0197163 A1
(43) Pub. Date: Jun. 19, 2025

(54) RETRACTOR FOR A BELT FOR RETAINING OBJECTS IN SPACE ENVIRONMENTS

(71) Applicant: SABELT S.P.A, Torino (IT)

(72) Inventors: Luca CAMPANELLA, Torino (IT); Giulio GRAZIANO, Torino (IT)

(21) Appl. No.: 18/982,963

(22) Filed: Dec. 16, 2024

(30) Foreign Application Priority Data
Dec. 18, 2023 (IT) 102023000026910

(51) Int. Cl. B65H 75/44

(52) U.S. Cl. CPC B65H 75/4447

(57) ABSTRACT

A retractor for a belt for retaining objects in space environments that has an outer housing containing a spool for the belt is associated with a centrifugally activated braking mechanism that allows the belt to unwind normally when the belt is pulled to extract the belt from the belt retractor. During a rewinding phase, the centrifugally activated braking mechanism automatically limits a rewinding speed of the belt on the spool.

### CROSS-REFERENCE TO RELATED APPLICATION

This application claims priority to Italian Patent Application No. 102023000026910 filed Dec. 18, 2023, the entire contents of which is hereby incorporated by reference in its entirety.

### FIELD OF THE INVENTION

The present invention relates to a retractor for a belt or tape for retaining objects in space environments.

### BACKGROUND OF THE INVENTION

In space or aerospace environments, in substantial weightlessness or reduced gravity environments, there is a need to restrain certain objects such as boxes, suits, cylinders or the like, by tying them to wall panels or other static structural elements of the environment to prevent such objects from floating freely in the environment.

For this purpose, the use of retractable belts or straps, substantially similar to seat belts, has been proposed. These are equipped with a retractor onto which the belt is wound to such an extent as to hold the attached object adjacent to the wall or other structural element of the environment. When the belt is not in use, it is completely rewound into the retractor. At the free end of the belt, there is a tab that snaps into a buckle located either on the retractor itself, causing the belt to form a closed loop, or at another point in the environment.

In a substantial near-zero gravity environment, the automatic rewinding of the belt, when the tab at the end of the belt is released, causes the belt to be rewound very quickly onto a reel due to the rewinding spring. This effect that rapid movement produces a whiplash is undesirable.

### SUMMARY OF THE INVENTION

In order to avoid the aforementioned drawback, the present invention provides a belt retractor for retaining objects in space environments associated with a centrifugally activated braking mechanism that allows normal unwinding of the belt when the belt is pulled to extract it from the retractor, and, during the rewinding phase, the braking mechanism automatically limits the speed at which the belt is rewound onto the spool.

Embodiments may provide for the retractor also to be fitted with a manually operated locking device which serves to stop the rotation of the spool, thereby temporarily locking the angular position of the spool and thus the length of the portion of the belt being unwound off the retractor.

### BRIEF DESCRIPTION OF THE DRAWINGS

In order that the present invention may be well understood, a few preferred embodiments of the invention will now be described, given by way of example, with reference to the accompanying drawings, in which:

FIG. 1 is a perspective view of a retractor in a closed condition;

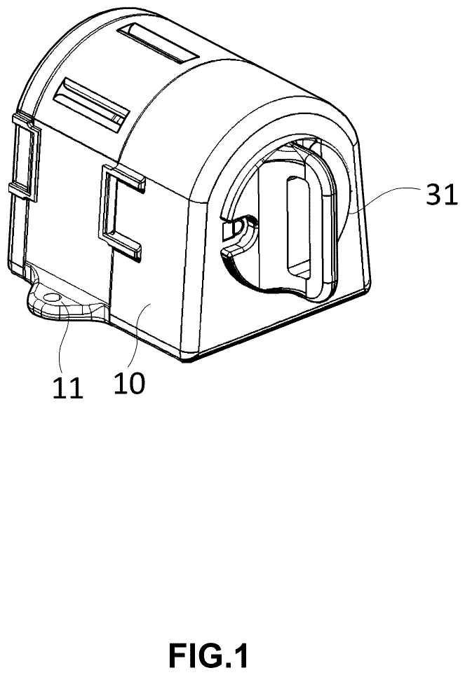

FIG. 2 is a cross-sectional view of the retractor of FIG. 1;

FIG. 3 is an exploded perspective view showing the components of the retractor of FIGS. 1 and 2;

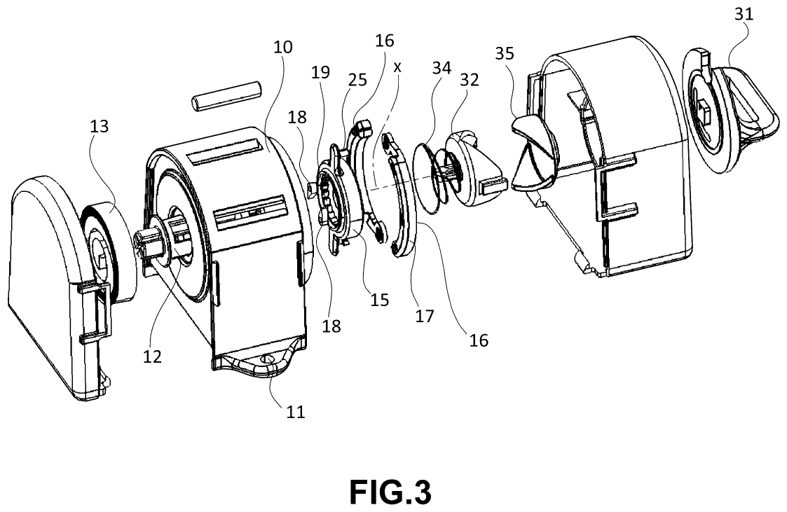

FIG. 4 is a cross-sectional view of the retractor of FIG. 1 in a condition in which a locking device is in an open or unlocked condition; and

FIG. 5 is a sectional view, similar to FIG. 4, showing a condition in which the spool is rotationally locked.

### DETAILED DESCRIPTION

Referring to the drawings, a belt or tape retractor for retaining objects in space environments comprises an outer housing 10, preferably of rigid plastic material, comprising the union of two or more complementary housing elements. The outer housing 10 is provided with appendages or projections or other means 11 for securing the retractor to a stationary support (not illustrated) in a space environment.

In the present context, the term ‘space environment’ means an environment such as a station or spacecraft or other means of transport located in regions of space with reduced or absent gravity.

The outer housing 10 contains a spool for winding and rewinding a belt for retaining objects, a braking mechanism associated with the spool and, optionally, a locking device capable of blocking the rotation of the spool.

On the spool 12, which is rotatable about an axis of rotation x, a belt (not illustrated) can be wound for retaining objects, such as cylinders, space suits, and other items that are not intended to float freely in the environment due to the substantial absence of gravity.

A rewinding spring 13, preferably a coil spring, is used to rotate the spool 12 in a direction that rewinds the belt onto the spool. An inner braking surface 14, having a concave cylindrical shape, is firmly fixed inside the outer housing 10.

A centrifugally activated braking mechanism is interposed between the spool 12 and the inner cylindrical braking surface 14. The braking mechanism comprises an intermediate annular support 15, rotation-sensitive locking means 18, 19 which are rotationally releasable and capable of rotationally connecting the spool to one or more braking bodies 16, which are frictionally sliding against the inner cylindrical braking surface 14.

The intermediate annular support 15, rotatable about the axis of rotation x and arranged concentrically to it, is arranged between the spool 12 and the inner cylindrical braking surface 14.

At least one movable braking body 16 movably mounted on the intermediate annular support 15 has a convex surface 17 elastically urged against the inner cylindrical braking surface 14.

Preferably, two movable braking bodies 16 are provided, mounted swinging on respective swing pins 25 spaced apart on the intermediate annular support, according to an arrangement of symmetry with respect to the axis of rotation x, each associated with an elastic element 24 which elastically stresses the movable braking bodies 16 in radially outer directions to bring their convex surfaces 17 to engage against the inner cylindrical braking surface 14.

According to an embodiment, the or each movable braking body 16 is configured as a brake shoe, mounted oscillating on a respective swing pin 25 on the intermediate annular support 15 and has its convex surface 17 facing the inner cylindrical braking surface 14. Preferably, the inner cylindrical braking surface 14 and the convex surfaces 17 have corresponding curvatures.

The centrifugally activated braking mechanism comprises mutually cooperating, rotation-sensitive locking means 18 and 19 acting between the spool 12 and the intermediate annular support 15, capable of rotationally locking the spool and the intermediate annular support in response to a rotation of the spool in a belt rewinding direction, and rotationally releasing the intermediate annular support from the spool in response to a rotation of the spool in a belt unwinding direction.

The rotation-sensitive locking means comprise at least one pawl 18 swingably mounted on the spool 12 about an axis of oscillation parallel to the axis of rotation x and having a free end 21 capable of swinging, in response to the rotation of the spool in the belt unwinding direction, towards a radially outwardly extended position.

Preferably, the rotation-sensitive locking means comprise two or more pawls 18 mounted swinging on the spool around respective axes of oscillation spaced apart and parallel to the axis of rotation x. In the exemplary embodiment illustrated in the drawings, two pawls are provided which are angularly spaced 180° around the axis of rotation x and have respective free ends 21 oriented in substantially opposite directions according to an angle of 180°.

The intermediate annular support 15 has a central cavity 20 which centrally accommodates the spool and forms a cavity around it. In the central cavity 20, a plurality of engagement recesses 19 radially spaced from the spool are formed integral or integral with the intermediate annular support 15, which are designed to cooperate operationally with the pawls 18 to form, together with the pawls 18, the rotation-sensitive locking means.

The engagement recesses 19 are circumferentially distributed around the spool 12 and each of them serves to lock, in a respective angular position, the spool 12. In particular, the engagement recesses each serve to lock, in a respective angular position of the spool 12, the free end 21 of the or each pawl 18 when the spool 12 rotates in the belt rewinding direction, but are configured not to lock the free end of the pawl when the spool rotates in the belt unwinding direction.

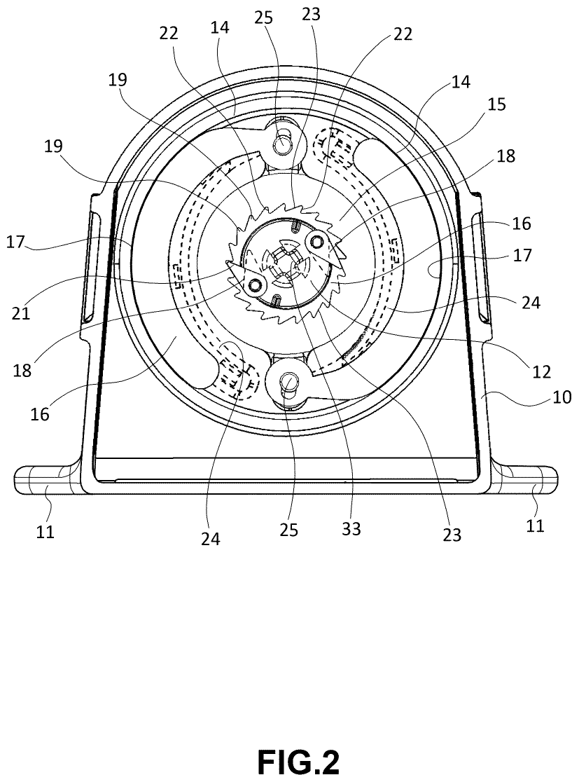

According to a preferred embodiment, as shown in FIG. 2, the engagement recesses 19 are configured in a saw-tooth pattern, with alternating faces 22 oriented in substantially radial directions with respect to the axis of rotation x and faces 23 inclined in substantially tangential directions with respect to the spool 12.

By virtue of the above-described arrangement, the centrifugally activated braking mechanism is capable of alternately and automatically reaching two operating arrangements: an unbraked arrangement and a braked arrangement. The braked arrangement is achieved when the spool 12 rotates in the belt unwinding direction, whereby the free ends of the pawls 18 slide over the points identified between the engagement recesses 19. In this condition, which occurs when a user pulls the belt and partially withdraws it from the retractor, unwinding it off the spool, the spool can rotate freely with respect to the inner cylindrical braking surface 14 and the outer housing 10 of the retractor.

The braking arrangement occurs automatically when the spool 12, under the action of the rewinding spring 13, rotates rapidly in the belt winding direction. In such a condition, the centrifugal acceleration acting on the spool rotates the pawls 18 in radially outward directions about their respective axes of oscillation, causing the free ends of the pawls to each engage in a respective engagement recess 19. The spool 12 is thus made rotationally integral with the intermediate annular support 15, rotating it around the axis of rotation x together with the movable braking bodies 16. The sliding friction that develops at the interface between the movable braking bodies 16 and the inner cylindrical braking surface 14 slows down or at least limits the angular speed of rotation of the spool rewinding, thus avoiding a whip effect of the belt that would otherwise be rewound too fast in substantial absence of gravity.

According preferred to a embodiment, the retractor also comprises a locking device 30 to block the rotation of the spool 12. The locking device comprises a manually operated member 31 mounted on the outer housing 10, a locking seat 33 integral with the spool 12, and an intermediate locking member 32 interposed between the manually operated member 31 and the spool 12.

The intermediate locking member 32 is a translating member slidably mounted inside the outer housing 10, manually operable by an operator who can act on the manually operated member in order to block the rotation of the spool 12 and temporarily fix the length of the section of tape extracted from the rewinder.

According to a preferred embodiment, the intermediate locking member 32 acts as a latch sliding axially in a direction parallel to or coincident with the axis of rotation x, without possibility of rotation about said axis. Axially extended guiding elements may be provided at the interface between the intermediate locking member and the outer housing 10 or a stationary element integral therewith.

In the illustrated example, the locking seat 33 on the spool 12 is provided by a plurality of elastic fingers substantially parallel to the axis of rotation x and protruding from a side face of the spool 12 angularly spaced about the axis of rotation x.

The locking device may further comprise a spring 34 that urges the intermediate locking member 32 away from the locking seat 33 on the spool 12.

In the exemplary embodiment illustrated, the manually operated member 31 is a rotatable knob member, operatively associated with the intermediate locking member 32 via a cam mechanism 35, 36 which, following a manual rotation imparted to the manually operated member 31, causes the intermediate locking member 32 to translate towards the locking seat 33 integral with the spool 12.

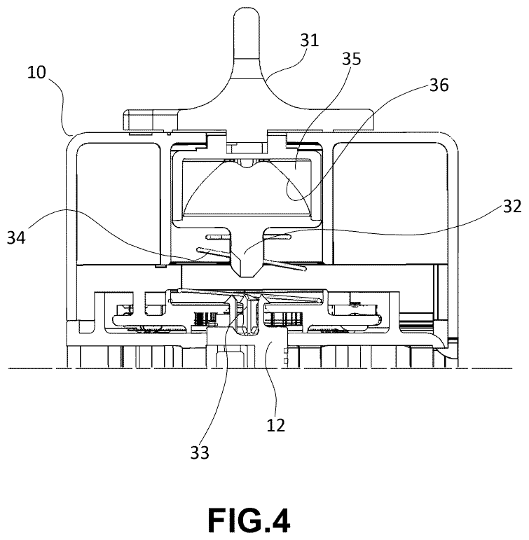

FIG. 4 illustrates a rotationally unlocked spool condition, in which the intermediate locking member 32 does not engage the spool 12, and therefore the user can lengthen and shorten the section of tape extracted from the retractor.

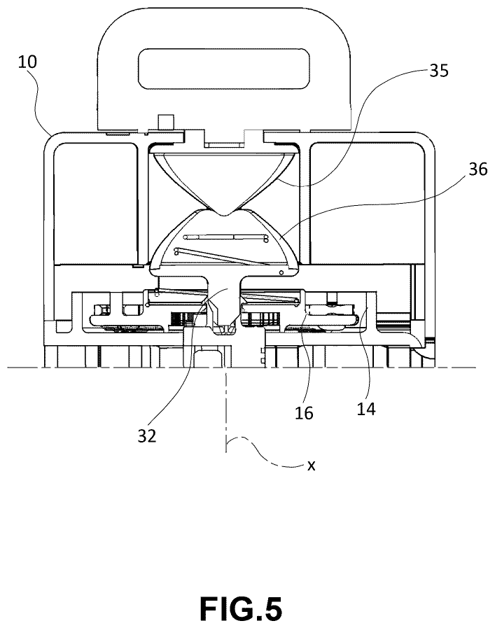

By rotating the manually operated member 31 to the position of FIG. 5, such rotation, by engaging the cam mechanism 35, 36, causes the intermediate locking member 32 to move to engage the locking seat 33, preventing it from rotating.

Various aspects and embodiments of the retractor have been described. It is understood that each embodiment may be combined with any other embodiment. Furthermore, the invention is not limited to the described embodiments, but may be varied within the scope defined by the appended claims.

What is claimed is:

1. A belt retractor for a belt for retaining objects in a space environment, the belt retractor comprising:
an outer housing having means for securely fixing the belt retractor to a stationary support in the space environment, wherein the outer housing contains:
a spool, rotatable about an axis of rotation, on which the belt can be wound;
a rewinding spring capable of rotating the spool about the axis of rotation in a direction of rotation which rewinds the belt on the spool;
an inner cylindrical braking surface, integral with the outer housing; and
a centrifugally activated braking mechanism, interposed between the spool and the inner cylindrical braking surface, wherein the centrifugally activated braking mechanism comprises
an intermediate annular support, rotatable about the axis of rotation and arranged between the spool and the inner cylindrical braking surface, at least one movable braking body, movably mounted on the intermediate annular support and having a convex surface elastically urged against the inner cylindrical braking surface, and
rotation-sensitive locking means acting between the spool and the intermediate annular support, capable of rotationally locking the spool and the intermediate annular support in response to a rotation of the spool in a belt rewinding direction, and rotationally releasing the intermediate annular support from the spool in response to a rotation of the spool in a belt unwinding direction;
whereby the centrifugally activated braking mechanism is capable of alternately and automatically reaching two operating arrangements:
an unbraked arrangement, when the spool is rotated in the belt unwinding direction, in which arrangement the spool can rotate freely with respect to the inner cylindrical braking surface; and
a braked arrangement, in which, when the spool is urged by the rewinding spring to rotate in the belt rewinding direction, the rotation of the spool in the belt rewinding direction causes the rotation-sensitive locking means to make the spool rotationally integral with the at least one movable braking body.

2. The belt retractor of claim 1, wherein the rotation-sensitive locking means comprise
at least one pawl swingably mounted on the spool about an axis of oscillation parallel to the axis of rotation and having a free end capable of swinging, upon rotation of the spool in the belt rewinding direction, in a radially outwardly extended position, and
a plurality of engagement recesses radially spaced apart from the spool and circumferentially distributed in a central cavity formed by the intermediate annular support, wherein the engagement recesses are configured to be capable of locking the free end of the at least one pawl when the spool rotates in the belt rewinding direction, and of not locking the free end of the at least one pawl when the spool rotates in the belt unwinding direction.

3. The belt retractor of claim 2, wherein the engagement recesses are configured in a saw-tooth pattern, with alternating faces oriented in substantially radial directions with respect to the axis of rotation and faces inclined in substantially tangential directions with respect to the spool.

4. The belt retractor of claim 1, wherein the rotation-sensitive locking means comprise two or more pawls swingably mounted on the spool around respective axes of oscillation spaced apart and parallel to the axis of rotation.

5. The belt retractor of claim 1, wherein the at least one movable braking body is configured as a brake shoe swingably mounted on an oscillation pin on the intermediate annular support and has the convex surface facing the inner cylindrical braking surface and having a shape partially congruent thereto.

6. The belt retractor of claim 1, wherein the at least one movable braking body is associated with at least one elastic element acting between the at least one movable braking body and the intermediate annular support to resiliently urge the at least one movable braking body against the inner cylindrical braking surface.

7. The belt retractor of claim 1, comprising two movable braking bodies, mounted for oscillation about respective swing pins spaced apart on the intermediate annular support, each associated with at least one elastic element urging the two movable braking bodies against the inner cylindrical braking surface.

8. The belt retractor of claim 1, wherein the belt retractor further comprises a locking device for locking the rotation of the spool, and wherein the locking device comprises:
a manually operated member mounted on the outer housing,
a locking seat integral with the spool, and
an intermediate locking member, interposed between the manually operated member and the spool, capable of reaching a locked position, in which the manually operated member holds the intermediate locking member engaged in the locking seat of the spool preventing the spool from rotating, and an unlocked position, in which the manually operated member allows the intermediate locking member to release from the locking seat of the spool, allowing the spool to rotate.

9. The belt retractor of claim 8, wherein the intermediate locking member is a translating member slidingly mounted within the outer housing.

10. The belt retractor of claim 8, wherein the locking device further comprises a spring that urges the intermediate locking member away from the locking seat of the spool.

11. The belt retractor of claim 8, wherein the manually operated member is a rotatable member, operatively associated with the intermediate locking member through a cam mechanism which, following a manual rotation imparted to the manually operated member, causes the intermediate locking member to translate towards the locking seat that is integral with the spool.
